(19) United States
(12) Patent Application Publication
(10) Pub. No.: US 2013/0266414 A1
(43) Pub. Date: Oct. 10, 2013

(54) Pan Stacker

(71) Applicant: Peter W. Anderson, Culpeper, VA (US)

(72) Inventor: Peter W. Anderson, Culpeper, VA (US)

(73) Assignee: AMF Automation Technologies, LLC d/b/a AMF Bakery Systems, Richmond, VA (US)

(21) Appl. No.: 13/441,159

(22) Filed: Apr. 6, 2012

(51) Int. Cl. B65G 57/03; B65G 57/04

(52) U.S. Cl. 414/793.2; 414/792.7

(57) ABSTRACT

Stacker 10 engages its end of arm tool 35 against a pan 40 and lifts the pan through an arc so that the pan revolves about its support framework 12 to a delivery position. The pair of lift arms 22 and 23 revolves about the pivot shaft 30 as the pivot shaft moves vertically so that the pans may be moved from a higher elevation to a lower elevation, and vice versa. The end of arm tool is maintained in its upright attitude throughout the movement by a timing belt 50 so that the pan is also deposited in the same attitude as when it was received.

### FIELD OF THE INVENTION

This invention concerns a stacker for vertically stacking or unstacking bakery pans and similar items. More particularly, the invention concerns a stacker that can retrieve multiple pans or lids from nested stacks by the use of magnetic retrievers and placing the pans on a conveyor system or pick them from the conveyor and stack them for storage.

### BACKGROUND OF THE DISCLOSURE

In the bakery industry, and in other industries, the work products require a support surface, such as bread products placed in bakery pans for baking. The bakery pans transport the work products through ovens and other processing stations, and after the work products have been completed, the work products are removed from the bakery pans, leaving the bakery pans for another cycle through the process.

A large number of bakery pans are required for mass production of the work products. The production process requires the placement of the bakery pans on the assembly line for receiving the work products, moving the pans bearing the work products through an oven and other processing stations, the retrieving of the bakery pans at the end of the production line, then stacking the bakery pans. This requires reliable and accurate movements of pan collectors, conveyors, retrieving carts, etc. Further, the bakery pans may be hot at the end of the processing line so that it may be hazardous and undesirable to manually stack and transport the hot pans.

The prior art includes a magnetic pan stacker or unstacker produced by AMF Bakery Systems, with information available at www.amfbakery.com. Another prior art stacking system is disclosed in U.S. Patent Publication 2004/0071539 A1 dated Apr. 15, 2004.

The known prior art pan stackers are considered to be relatively slow and expensive to produce and maintain. Generally, the prior art products occupy large floor space and the structures are complex and costly to construct, and the area for placing the pans at the retrieval and delivery ends of the stacker is not easily accessible.

Accordingly, it is desirable to design a simpler automated pan management system that is capable of continual or intermittent operation with the stacking and unstacking of pans of various shapes and sizes, usually without requiring replacement of parts to accommodate pans of different sizes and configurations. Further, it is desirable to design a pan management system, or stacker, which is free of framework obstructions, with ready access to both the entrance and delivery sides of the pan stacker for ease and convenience of retrieving pans from the stacker and for delivering pans to the stacker.

### SUMMARY OF THE DISCLOSURE

This disclosure concerns an automated stacker and management system for pans such as bakery pans and similarly shaped products.

The stacker may include a support framework, a pair of parallel spaced apart lift arms that work in unison, each including a support end rotatably positioned at the support framework, and a distal end that revolves about the support framework. An end of arm tool is mounted to the distal ends of the lift arms and revolves with the lift arms from one side to the other side of the support framework to pick up pans on one side of the framework and deliver the pans to the other side of the framework.

Power means are used to revolve and to vertically lift and lower the lift arms. The power means may include a first power means positioned at the support framework that revolves the distal ends of the lift arms in unison over the support framework, and a second power means that is positioned at the support framework and raises and lowers the support ends of the lift arms.

The distal ends of the lift arms support the end of arm tool and lift the end of arm tool from one side of the support framework to the other side of the framework, revolving the end of arm tool above the support framework, and lowering the end of arm tool on the other side of the framework.

The support framework includes a pair of spaced, parallel upstanding supports (“towers”). A lift plate assembly may be supported by each tower and used to raise and lower the lift arms and to revolve the lift arms. A horizontal pivot shaft may extend between the lift plate assemblies and support the lift arms and be rotatably mounted at each of its ends to the lift plate assemblies.

A timing belt control sprocket may be mounted concentrically with the horizontal pivot shaft and non-rotatably supported by the lift plate assemblies, and is vertically movable with the lift plate assemblies and the horizontal pivot shaft. A timing belt extends about the timing belt control sprocket and also about the tool support shaft, such that the timing belt tracks about the timing belt control sprocket and rotates the tool support shaft in unison with the revolving of the lift arms about the pivot shaft. This maintains the end of arm tool in an upright attitude as the end of arm tool revolves about the pivot shaft at the ends of the lift arms.

The net result is that bakery pans and other items may be retrieved on one side of the stacker, lifted over the stacker, and delivered on the other side of the stacker. Further, the stacker is constructed such that the pans may be retrieved at one elevation and stacked at another elevation, and the operation of the end of arm tool can be reversed. This permits the device to both stack and unstack the pans, such as baking pans and similarly shaped items.

The end of arm tool may include a plurality of retrievers for engaging and adhering to the pans so as to lift the pans. The retrievers may include magnets, such as permanent magnets, and the retrievers also may include an air actuated cylinder for pushing the pans away from the magnets, thereby breaking the magnetic attraction between the magnets and the pans, assuring timely and effective discharge of the bakery pans, etc. from the end of arm tool.

The support ends and distal ends of the lifting arms may form an L-shape, and when the end of arm tool is retrieving and depositing pans, the distal ends of the lifting arms are positioned in a horizontal attitude and the support ends are positioned in a vertical attitude, and the end of arm tool is positioned away from the support framework.

The distal ends of the lift arms are long enough to move the end of arm tool beyond the towers so that the pans may be retrieved from and stacked in positions that can allow the pans to approach at any angle on the sides of the towers.

Other objects, features and advantages will be understood from reading the following specification when taken in conjunction with the accompanying drawings.

### BRIEF DESCRIPTION OF THE DRAWINGS

FIG. 1 is a perspective illustration of the stacker for stacking a series of pans, showing the end of arm tool in its raised position.

FIGS. 2A, 2B and 2C are progressive illustrations of the operation of the stacker.

FIG. 3A is a perspective view of the lift arms and pivot shaft of the stacker.

FIG. 3B is a top view of the pivot arms and pivot shaft of the stacker.

FIG. 3C is an elevational view of a lift arm, showing the timing belt with the cover removed.

FIG. 3D is an end view of the lift arms and pivot shaft.

FIGS. 4A-4E are progressive illustrations of the stacker as the stacker retrieves, revolves, and delivers the pans, and showing the attitudes of the timing belt control sprocket and the tool support shaft during their movements.

FIG. 5A is a perspective illustration of the end of arm tool mounted to the tool support shaft.

FIG. 5B is a top view of the end of arm tool and the tool support shaft.

FIG. 5C is a side view of the end of arm tool.

FIG. 5D is an end view of the end of arm tool and the tool support shaft.

FIG. 5E is a detailed perspective illustration of the air control conduits as they lead to the air operated retrievers.

FIG. 6A is a telescoped perspective view of one of the air operated permanent magnet retrievers.

FIG. 6B is a side view of the air operated magnet of FIG. 6A.

FIG. 6C is an exploded perspective illustration of the air operated magnetic retriever of FIGS. 6A and 6B.

FIG. 6D is an end view of the air operated magnetic retriever of 6A-6C.

FIG. 7A is a perspective view of the lift plate assembly, which moves the pivot shaft and the timing belt control sprocket vertically.

FIG. 7B is an expanded illustration of the components of the lift plate.

FIG. 7C is a perspective view of the lift arms and the servo motor, gear reducer and lift plate that are engaged with the pivot shaft and lift arms while rotating the pivot shaft and revolving the lift arms about the pivot shaft.

FIG. 7D is a perspective view of the pair of lift plates and the lifting screws with the ball screw nuts that lift and lower the pivot shaft and the lift arms.

### DETAILED DESCRIPTION

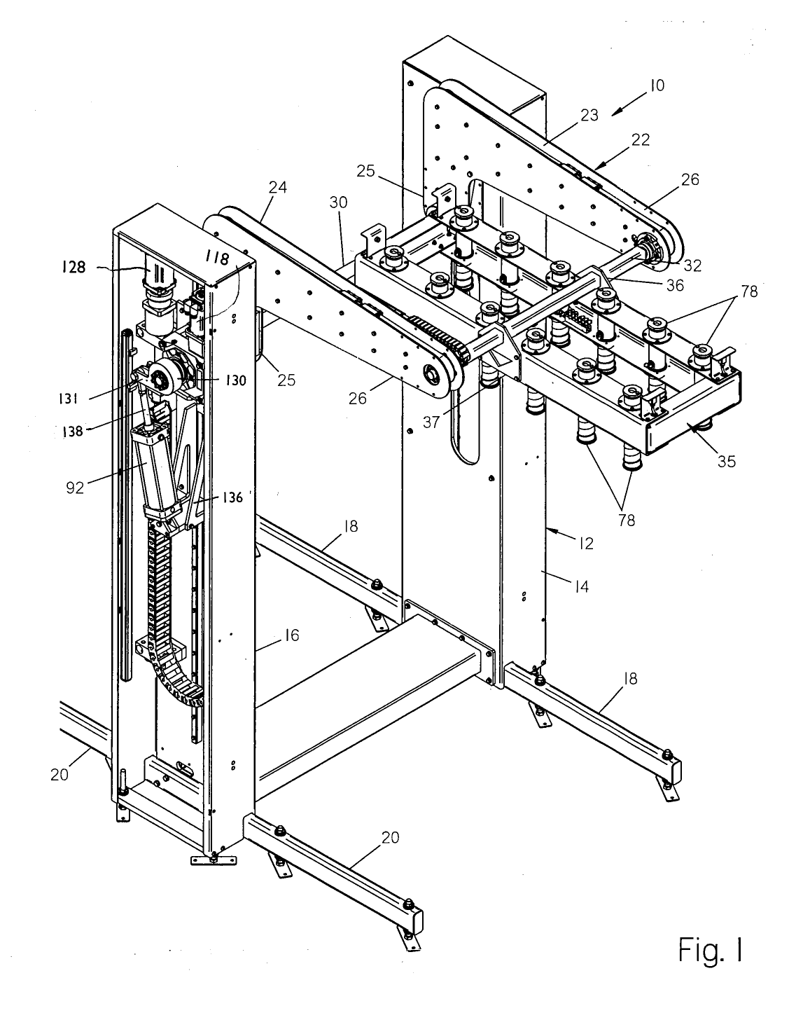

Referring now in more detail to the drawings, in which like numerals indicate like parts throughout the views, FIG. 1 illustrates a stacker 10 for stacking a series of bakery pans and the like. The stacker includes a support framework 12 that includes a pair of spaced towers 14 and 16 with stabilizing horizontal outriggers 18 and 20.

A pair of parallel, spaced apart lift arms 22 is supported by the support framework, with the pair of lift arms including parallel lift arms 23 and 24. The lift arms 23 and 24 each include a support end 25 and a distal end 26. The support ends and distal ends of each lift arm may be L-shaped, with the support ends 25 movable between upright and inverted attitudes, and the distal ends 26 being movable between oppositely directed horizontal attitudes. The lift arms may be formed in other shapes. The lift arms will be described in more detail hereinafter.

Horizontal pivot shaft 30 extends through the support ends 25 of the pair of lift arms 22, and is also mounted and supported by the spaced towers 14 and 16 of the support framework 12. The pivot shaft 30 is movable vertically with respect to the towers 14 and 16 and is rotatable. This will be disclosed in more detail hereinafter.

Tool support shaft 32 is mounted at its ends to the distal ends 26 of the pair of lift arms 22, and the tool support shaft is also rotatable with respect to the pair of lift arms 22.

An end of arm tool 35 is supported on the tool support shaft 32. The end of arm tool 35 is suspended from the tool support shaft 32 by support brackets 36 and 37.

Tool support shaft 32 is shown in square cross section, but may be formed in other cross-sectional shapes. The support brackets 36 and 37 each may include an opening that matches the cross-sectional shape of the tool support shaft so that the end of arm tool 35, or some other connection that will maintain the same angular attitude as the tool support shaft 32.

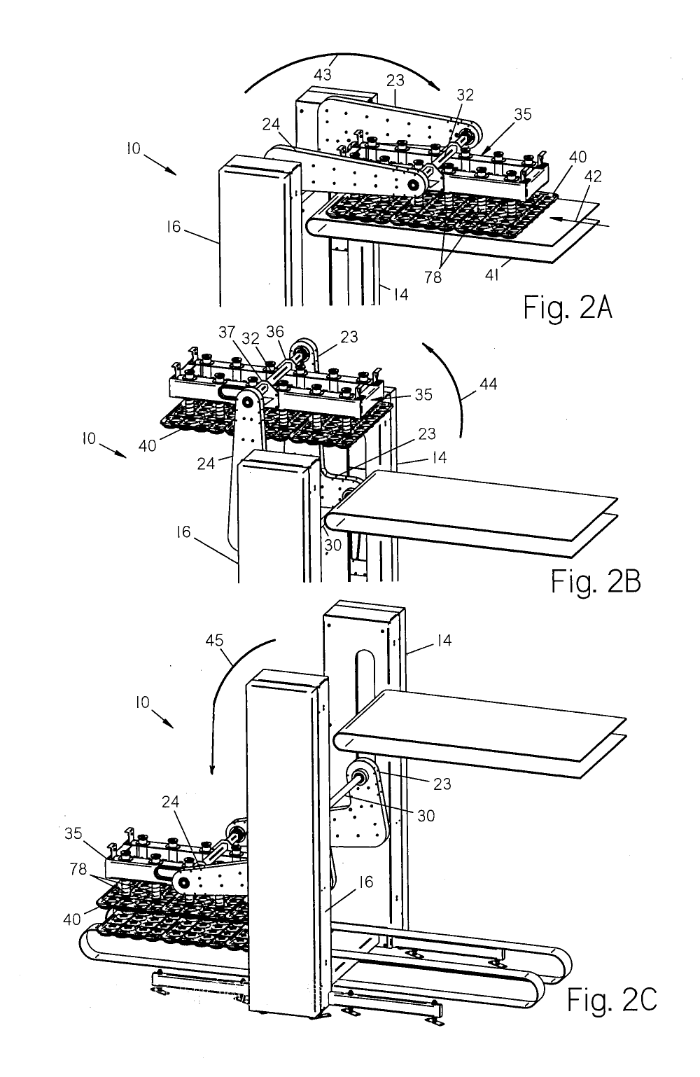

As shown in FIGS. 2A, 2B, and 2C, the stacker 10 retrieves a pan 40, or an accumulation of stacked pans 40, from a conventional conveyor, such as a surface conveyor 41. The conveyor 41 advances the pans toward the stacker 10 as indicated by arrow 42. Conveyor 41 is illustrated as moving toward the space between the towers 14, 16; however, the conveyor may be directed at other angles toward the towers since the pick-up position and delivery position of the end of arm tool 35 are spaced longitudinally away from the towers. When the pans reach the stacker 10, the stacker will move the end of arm tool 35 downwardly, usually in a downward arc 43 (FIG. 2A), so that the end of arm tool 35 moves to engage the top surface of the top pan 40.

Once the end of arm tool has engaged and has become connected to the pan 40, as shown in FIG. 2A, it may move up and then revolve as indicated by arrow 44 in FIG. 2B, in an upward arc about the towers 14 and 16, and then in a downward arc as indicated by arrow 45 in FIG. 2C, to revolve about the pivot shaft, and then move down to place the pan 40 in a rest position on a cart, conveyor or other surface upon which a stack of pans may be formed.

While the stacking procedure illustrated in FIGS. 2A-2C is from right to left which is from a high position to a low position, the stacking procedure may be revised to lift from and lower to different heights, and to retrieve and deliver in opposite directions.

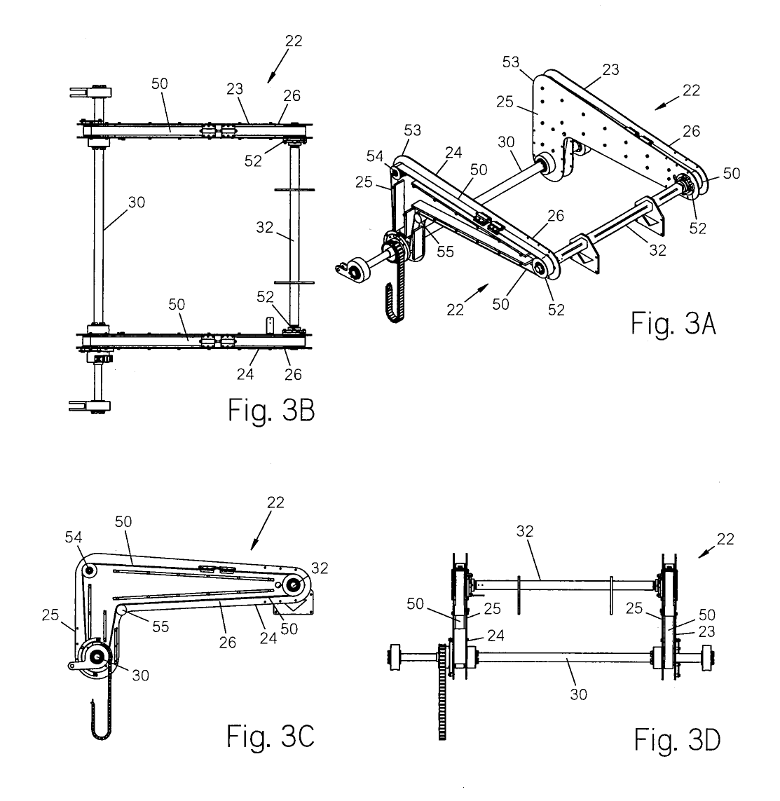

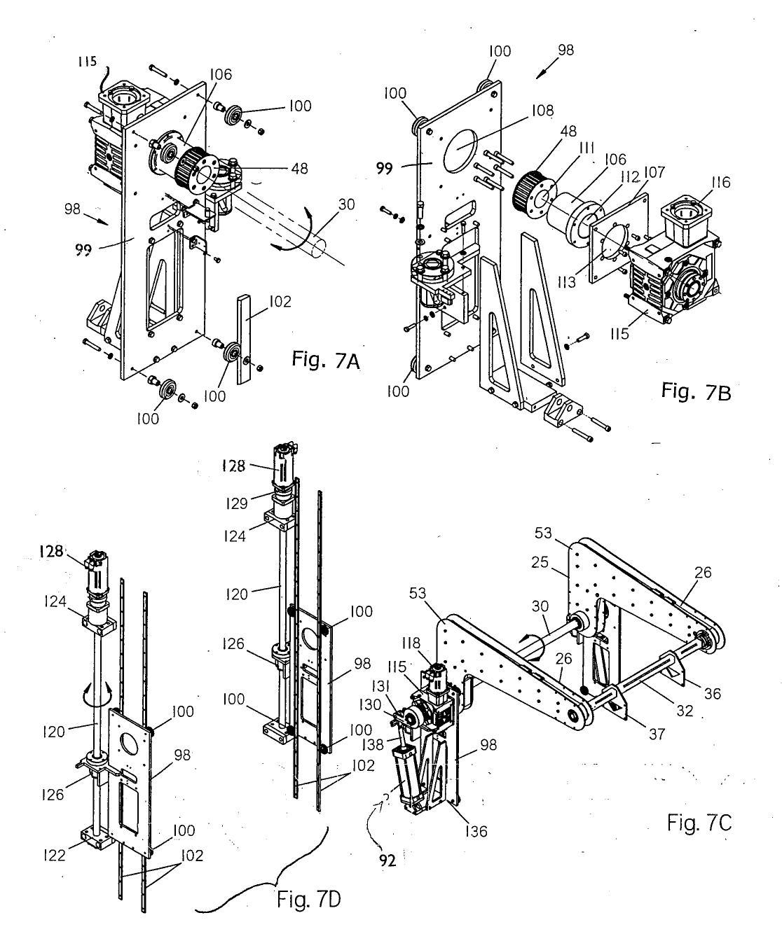

FIGS. 3A-3D illustrate the pair of lift arms 22 in more detail. The lift arm 24 as shown inn FIG. 3A has its exterior cover removed so the timing belt 50 is exposed. The lift arms include the support end 25 and the distal end 26 that may form in an L-shape. The support end 25 of the lift arm 24 includes a non-rotatable timing belt control sprocket 48 (FIG. 7A) that is coaxial with and non-rotatably mounted about rotatable pivot shaft 30, but is movable vertically with the pivot shaft 30, as will be described later in more detail.

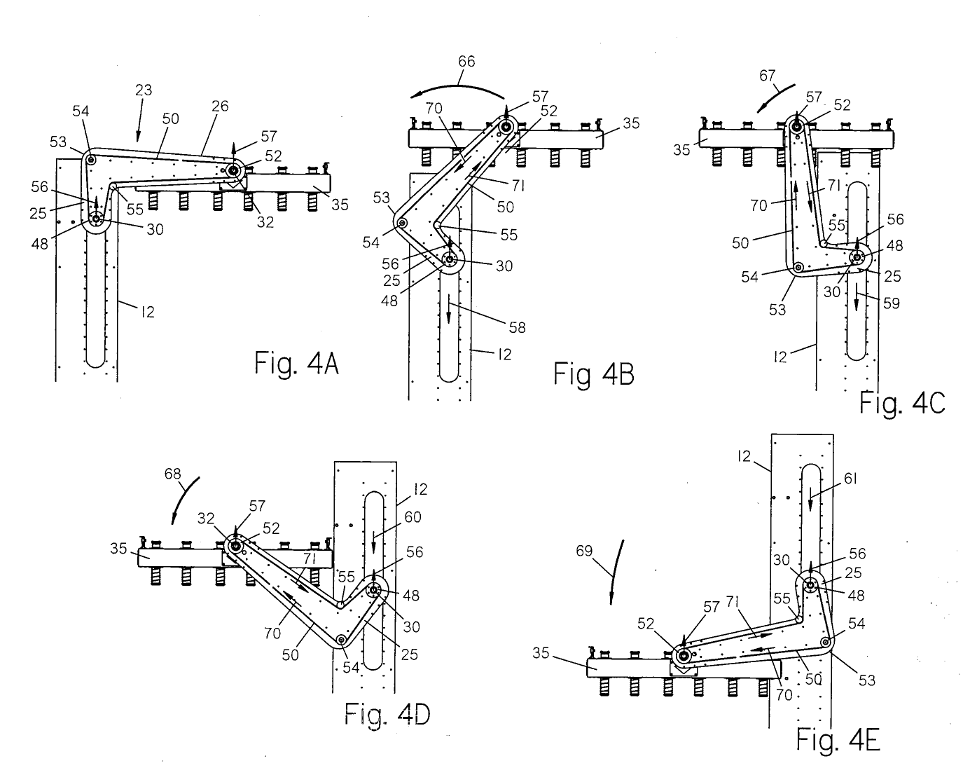

As shown in FIGS. 3A-3D and FIGS. 4A-4E, timing belt 50 extends about the non-rotatable timing belt control sprocket 48 at the end of the support arm 25, and also extends about an attitude control sprocket 52 that is mounted to an end of the pivot shaft 30 at the distal end 26 of the lift arm 24. The timing belt 50 also may extend about guide sprockets, such as sprockets 54 and 55, to guide the timing belt around the elbow 53 of the lift arm 24. The timing belt control sprocket 48 and the attitude control sprocket 52 have the same circumferences.

The timing belt control sprocket 48 may move vertically but does not rotate as it moves vertically. As the lift arms 23, 24 and the tool support shaft 32 revolve about the pivot shaft 30, the timing belt simultaneously wraps about one side of the non-rotatable timing belt control sprocket and unwraps about the other side of the timing belt control sprocket. This moves the spans of the timing belt 50 extending between the timing belt control sprocket 48 and the attitude control sprocket 52 as indicated by the movement arrows 70 and 71 in FIGS. 4B-4E. The movements of the timing belt in this way causes the attitude control sprocket 52 and the tool support shaft 32 at the distal ends 26 of the lift arms 24 to rotate with respect to the distal ends of the lift arms.

The rotation of the tool support shaft is equal to the arc at which the timing belt wraps on one side and unwraps on the other side around the timing belt control sprocket 48. This causes the end of arm tool 35 suspended from the tool support shaft 32 to remain upright during the revolving of the end of arm tool about the towers 14 and 15.

In order for this constant orientation to be maintained, the attitude control sprocket 52 must have the same circumference as the circumference of the timing belt control sprocket 48. If it is desired to tilt the end of arm tool 35 during its revolving movements from right to left of the support framework, the attitude control sprocket 52 of the pivot shaft 30 may be of a different circumference than the circumference of the timing belt control sprocket 48.

As illustrated in FIGS. 4A-4E, the timing belt control sprocket 48 has a direction arrow 56 applied to it, and the attitude control sprocket 52 also has a direction arrow 57 applied to it. The directional arrows 56 and 57 indicate upward directions. The movement arrows 58, 59, 60, and 61 of pivot shaft 30 indicate a simultaneous downward movement of the timing belt control sprocket 48 and pivot shaft 30.

As shown in FIG. 4A-4E, the end of arm tool 35 starts its upward revolving movement from an elevated position on the right side of the support framework 12, but the pivot shaft may simultaneously begin its downward vertical movement as shown at 58-61, resulting in a small total upward movement of the end of arm tool. As the end of arm tool continues and begins its downward revolving movements 67-69 as shown in FIGS. 4C to 4E, the downward revolving movement and the downward vertical movements 59-61 add together and increase the velocity of the end of arm tool and move the end of arm tool to a level lower than the beginning level shown in FIG. 4A.

During the movements described above, the orientation of tool support shaft 32 remains constant as indicated by the direction arrow 57, in the same direction as the direction arrow 56 of the timing belt control sprocket 48. This constant orientation of the pivot shaft 30 during the revolving movements maintains the end of arm tool 35 in its original attitude.

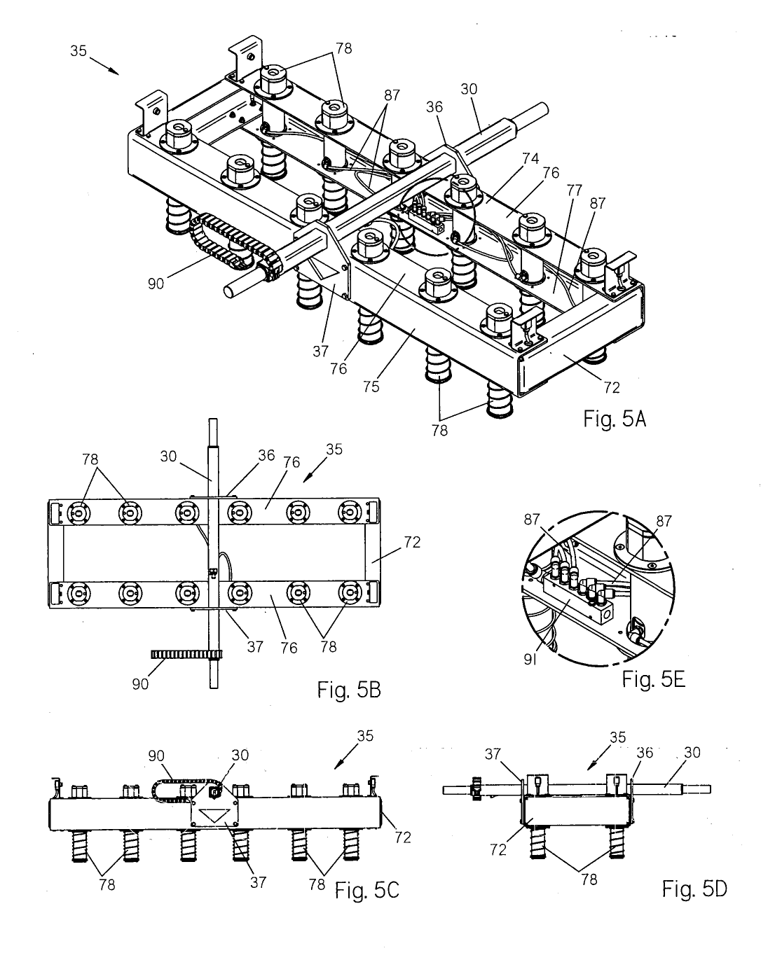

FIGS. 5A-5D illustrate the end of arm tool support frame 72 that includes a pair of parallel inwardly facing U-shaped support beams 74 and 75. A plurality of magnet units 78 are supported by the U-shaped support beams 74 and 75. In the embodiment illustrated, there are two rows of six magnet units 78.

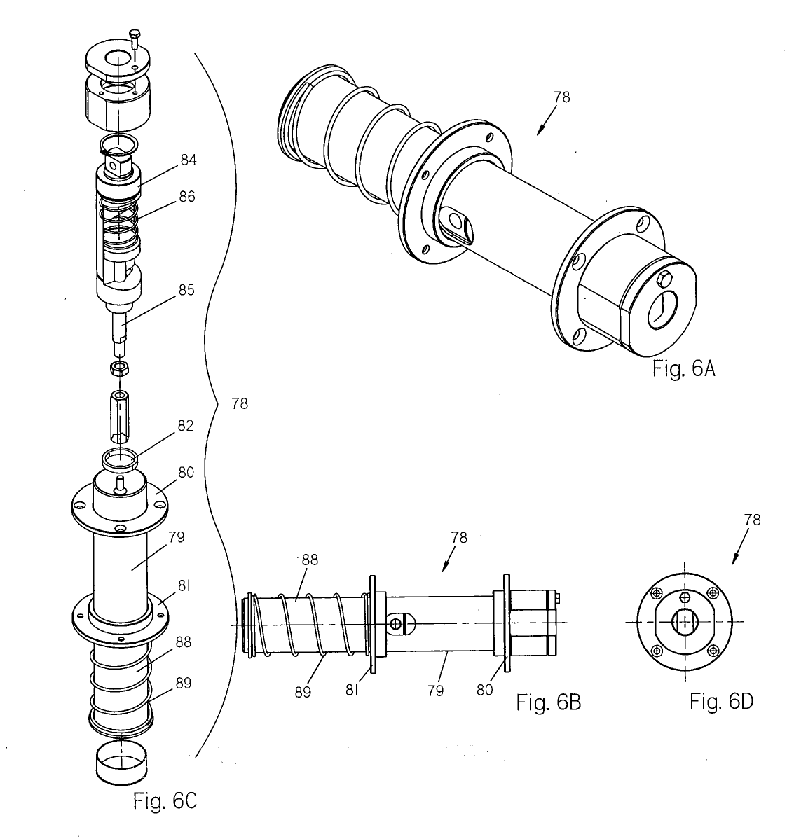

As shown in FIG. 6C, each magnet unit includes an exterior tubular housing 79 that extends through openings of the horizontal flanges 76 and 77 of the U-shaped support beams 74 and 75 of FIG. 5A. The circular flanges 80 and 81 of the tubular exterior housing 79 are mounted against the surfaces of the horizontal flange of the U-shaped support beams. Each magnet unit 78 includes a permanent magnet 82 that is supported on the end of a single acting reversible air operated cylinder 84. The internal coil compression spring 86 is positioned in the air operated cylinder 84 and biases the piston rod 85 and the permanent magnet 82 downwardly toward contact with the pan.

As shown in FIG. 5A, a source of air pressure is communicated through the air transfer tubes 87 into the tubular exterior housing 79, and into the air cylinder 84 of each magnet unit 78. Without air pressure, the piston rod moves downwardly via the spring 86. With this arrangement, the permanent magnet is biased downwardly to the end of arm tool support frame 72 and exterior housing 79 toward engagement with the pans 40 (FIGS. 2A-2C), making sure that each magnet of all of the magnet units makes a firm engagement with the end of arm tool support frame.

The coil compression spring 86 within the cylinder 84 of the magnet units 78, as well as the impact spring 89 that surrounds the tubular telescopic extension of the exterior housing 79, reduce the force initially applied by the magnet units against the pan.

When the end of arm tool 35 has been moved to the delivery point where the pans 40 are to be released, air under pressure is communicated through the air transfer tubes 87 (FIG. 5A) carried by the end of arm tool support frame to the air operated cylinders 84, to retract the magnets 82 of the cylinders away from the pan, thereby collapsing the magnetic field applied by the magnets to the pan and releasing the pan.

The air operated cylinder and permanent magnet carried by the air operated cylinder are telescopically received within the exterior tubular housing 79, forming each magnet unit as illustrated in FIGS. 6A and 6B.

The coil compression spring 89 extends about the lower portion of the exterior tubular housing 79 so that it may be retracted in response to a force applied between the end of arm tool 35 and the pans 40.

As shown in FIG. 5A, a wire way 90 supplies the pressurized air to the manifold 91 which feeds the pressurized air to the air transfer tubes 87 that lead to the magnet units 78.

While the end of arm tool has been disclosed in detail, it should be understood that other types of end of arm tools may be utilized in combination with the remaining parts of the stacker 10.

Also, while the products being stacked have been described herein as bakery pans 40, other types of products may be handled by the stacker 10. The expressions “pans” and “bakery pans” are to include other types of products.

FIGS. 7A and 7D illustrate a lift plate assembly 98 which is positioned in each tower 14 and 16 for lifting the ends of the pivot shaft 30, the timing belt control sprocket 48 and the pair of lift arms 22. The lift plates 99 are oriented vertically and include guide wheels 100 at their corners that engage vertical guide rails 102 (FIGS. 7D and 7E). The guide wheels have a peripheral surface that is V-shaped, and the guide rails have a complementary V-shaped guide edge so that the peripheral surfaces of the guide wheels register with the guide edge of the guide rail.

As shown in FIGS. 7A and 7B, timing belt control sprocket 48 is rigidly mounted to a stand-off sleeve 106, with the stand-off sleeve being rigidly mounted to mounting plate 107, with the mounting plate 107 shown in FIG. 7B as being rigidly mounted to the lift plate 99. With this arrangement, the timing belt control sprocket 48 is telescopically mounted through the large lift plate opening 108, with the stand-off sleeve 106 maintaining the timing belt control sprocket 48 spaced away from the face of the lift plate 99 (FIG. 7A). The pivot shaft 30 (FIG. 7A) is inserted through the aligned opening 108 of the lift plate 99, through the central opening 111 of timing belt control sprocket 48, through the central opening 112 of the stand-off sleeve 106, through the opening 113 of the mounting plate 107, into registration with a right angle gear reducer 115. The first power means such as a servo motor 118 (FIG. 7C) is mounted at position 116 of the gear reducer, and the servo motor controls the rotary movement of the pivot shaft 30 (FIG. 7B). The pivot shaft 30 may rotate independently of the vertical movements of the lift plate 99.

As shown in FIG. 7D, the vertical movement of lift plate 99 is applied by a second power means that may include rotary lifting screw 120 that is rotatably mounted at its ends to end bearings 122 and 124, with the rotary lifting screw having a helical thread imposed thereon (not shown). A ball screw nut 126 is attached to the rotary lifting plate 99. The ball screw nut includes internal helical threads that surround and engage the threads of the lifting screw 120, so as the lifting screw rotates, the ball screw nut 126 moves vertically along the rotary lifting screw 120 and carries the lifting plate 99 up and down along its vertically oriented guide rails 102. Servo motor 128 also is supported by the end bearing 124, through gear reducer 115, so that the servo motor 128 and its lifting screw 120 function as a second power means to lift the lift plate 99.

FIGS. 1, 2A and 2C illustrate that the distal ends 26 of the lift arms 23 and 24 and the end of arm tool 35 project horizontally from the towers 14 and 16 when in their laterally extending pick-up positions or delivery positions, so that their weights apply a substantial downward twisting force to the pivot shaft 30. As shown in FIGS. 1 and 7C, rotary link 130 is rigidly mounted at its center point to pivot shaft 30, and its connector arm 131 extends laterally therefrom. Air charged cylinder 92 is mounted to a support bracket 136 that extends rigidly from lift plate 99. The retractable cylinder arm 138 of the cylinder 92 is connected to the connector arm 131 of the rotary link arm 130. The air charged cylinder applies counter twisting forces to the pivot shaft 30 to balance the weight applied to the pivot shaft by the lift arms 23 and 24 and the end of arm tool 35.

The servo motors carried by lift plate 99 are controlled by a computer program so that the lifting movements and revolving movements applied to the end of arm tool 35 may be independent of each other.

While the foregoing specification describes an end of arm tool using magnet units, other types of grasping devices may be used, such as, but not limited to, suction bellows and suction cups. While the lift arms are described as being L-shaped, other shapes may be used. The timing belt control sprocket has been illustrated as cylindrical wheel with ribs, but other shapes of the sprocket may be used.

Although a preferred embodiment of the invention has been disclosed in detail herein, it will be obvious to those skilled in the art that variations and modifications of the disclosed embodiment can be made without departing from the spirit and scope of the invention as set forth in the following claims.

1. A stacker for stacking a series of pans, comprising:
a support framework including a pair of spaced towers,
a horizontal pivot shaft rotatably mounted at its ends to said towers,
a pair of parallel spaced apart lift arms, each said lift arm including a support end and a distal end, said support end of each lift arm mounted to said horizontal pivot shaft, and said distal ends of said lift arms revolvable about said horizontal pivot shaft,
power means for raising and lowering said horizontal pivot shaft,
a tool support means rotatably mounted to said distal ends of said lift arms and revolvable with said lift arms about said horizontal pivot shaft,
an end of arm tool mounted and rotatable and revolvable with respect to said tool support shaft,
a timing belt control sprocket mounted concentrically with said horizontal pivot shaft and non-rotatably supported by one of said towers and vertically movable with said horizontal pivot shaft, and
a timing belt extending about said timing belt control sprocket and connected to said tool support means,
such that said timing belt tracks about said timing belt control sprocket and rotates said tool support means in unison with the revolving of said lift arms about said pivot shaft and maintains said end of arm tool in an upright attitude as said end of arm tool revolves about said pivot shaft.

2. The stacker of claim 1, wherein said support end and said distal ends of said lift arms form an L-shape with respect to each other, and said support ends are movable between lowered and raised vertical positions and said distal ends movable between lowered and raised horizontal positions.

3. The stacker of claim 2, and further including idler sprockets mounted at the intersection of said support end and said distal end of said lift arms, and said timing belt is movable about said idler sprockets.

4. The stacker of claim 1, wherein said end of arm tool is suspended from said tool support shaft.

5. The stacker of claim 1, wherein said end of arm tool includes a plurality of retrievers for engaging and adhering to pans.

6. The stacker of claim 5, wherein said retrievers each include at least one permanent magnet for engaging pans.

7. The stacker of claim 5, wherein said retrievers comprise an array of retrievers supported in a common plane.

8. The stacker of claim 6, wherein said permanent magnets include an air actuated cylinder for urging said pan away from said permanent magnets.

9. The stacker of claim 1, wherein said distal ends of said lift arms, said tool support shaft and said end of arm tool being revolvable from one side to the other side and over said horizontal pivot shaft.

10. A stacker for stacking a series of pans, comprising:
a support frame,
a pair of parallel spaced apart lift arms, each said lift arm including a support end and a distal end,
a tool support shaft rotatably mounted to said distal ends of said lift arms,
a pivot shaft mounted at its ends to said support frame and to said support ends of said lift arms,
power means for simultaneously lowering said support ends of said lift arms while revolving said distal ends of said lift arms and said tool support shaft from a high position on one side of said support frame to a lower position on the other side of said support frame,
a non-rotatable timing sprocket movable vertically with the movements of said support end of one of said lift arms,
a timing belt extending from said non-rotatable timing sprocket at said support end of said lift arms to said tool support shaft at the distal ends of said lift arms for rotating said tool support arm in response to the revolving of said tool support shaft about said pivot shaft,
an end of arm tool suspended from said tool support shaft, and pan retrievers mounted to said end of arm tool.

11. The stacker of claim 10, wherein an end of arm tool is non-rotatably suspended from said tool support shaft.

12. The stacker of claim 10, wherein said support end and said distal ends of said lift arms form an L-shape and said support ends move between lowered and raised vertical attitudes and said distal ends move between lowered and raised horizontal attitudes.

13. The stacker of claim 10, wherein said end of arm tool includes retrievers for engaging and adhering to pans.

14. The stacker of claim 13, wherein said retrievers comprise at least one magnet.

15. The stacker of claim 14, wherein said at least one magnet includes an array of permanent magnets supported in a common plane.

16. The stacker of claim 15, wherein said magnets include an air actuated cylinder for urging said pan away from said permanent magnets.

17. The stacker of claim 10, wherein said distal ends of said lift arms, said tool support shaft and said end of arm tool are revolvable from one side to the other side of said horizontal pivot shaft.

18. A stacker for stacking a series of pans, comprising:
a support framework,
a pair of parallel spaced apart lift arms supported by said support framework, each said lift arm including a support end and a distal end,
an end of arm tool pivotally supported by said distal ends of said lift arms for engaging and lifting the pans,
first power means positioned at said support framework and connected to at least one of said support ends of said lift arms and constructed to raise and lower said support ends of said lift arms,
second power means positioned at said support framework and connected to at least one of said support ends of said lift arms and constructed to revolve said distal ends of said lift arms over said support framework,
such that the distal ends of said lift arms lift the end of arm tool on one side of said support framework, revolve the end of arm tool above the support framework, and lower the end of arm tool on the other side of the framework.

19. The stacker of claim 18, wherein said lift arms include a timing belt extending between said support end and said distal end of at least one of said lift arms for maintaining said end of arm tool in an upright attitude during the revolving of said end of arm tool above the support framework.

20. The stacker of claim 18, and further including a timing belt support sprocket non-rotatably supported at said support framework in a position wherein said timing belt wraps around one side of said timing belt support sprocket and unwraps around the other side of said timing belt support bracket in response to the end of arm tool revolving about said support framework.

21. The stacker of claim 18, wherein said end of arm tool includes a plurality of magnets for engaging and lifting said pans.

22. The stacker of claim 18, and further including means for resisting the force of gravity applied to said end of arm tool when said end of arm tool is positioned laterally of said support framework.

23. The stacker of claim 18, wherein
said support ends and said distal ends of said lifting arms are L-shaped,
and when the end of arm tool is retrieving and depositing pans said distal ends of said lifting arms are positioned in a horizontal attitude and said support ends are positioned in a vertical attitude and said end of arm tool is positioned away from said support framework.

24. The stacker of claim 18, and further including a timing belt sprocket coaxially mounted to the axis of rotation of said support ends of said lifting arms.

25. A stacker for stacking a series of pans, comprising:
a support framework,
a pair of parallel spaced apart lift arms supported by said support framework, each said lift arm including a support end and a distal end,
an end of arm tool pivotally supported by said distal ends of said lift arms for engaging and lifting the pans,
power means positioned at said support framework and connected to said support ends of said lift arms and constructed to revolve said distal ends of said lift arms over said support framework, such that the distal ends of said lift arms revolve the end of arm tool over the support framework, and
means for maintaining said end of arm tool in an upright attitude as said end of arm tool revolves above the support framework.

26. The stacker of claim 25, and further including an air activated cylinder connected to said support ends of said lift arms for resisting the force of gravity applied to said end of arm tool when said end of arm tool is positioned laterally of said support framework.

27. The stacker of claim 25, and further including a timing belt extending from said support end to said distal end of one of said lift arms, a timing belt support sprocket non-rotatably supported by support framework at said support ends of said lift arms in a position wherein said timing belt wraps around one side of said timing belt support sprocket and unwraps around the other side of said timing belt support bracket in response to the end of arm tool revolving about said support framework.
